(19) United States
(12) Patent Application Publication
(10) Pub. No.: US 2013/0268289 A1
(43) Pub. Date: Oct. 10, 2013

(54) Dietary Analysis Tool

(71) Applicant: STOKELY-VAN CAMP, INC., Chicago, IL (US)

(72) Inventors: Kimberly Marie White-Stein, Lombard, IL (US); Leslie J. Bonci, Pittsburgh, PA (US); Lisa Esposito-Heaton, Palatine, IL (US); Page Geraldine Love, Atlanta, GA (US); Jacqueline Raymonde-Berning, Castle Rock, CO (US)

(73) Assignee: Stokely-Van Camp, Inc., Chicago, IL (US)

(21) Appl. No.: 13/826,245

(22) Filed: Mar. 14, 2013

Related U.S. Application Data
(60) Provisional application No. 61/620,573, filed on Apr. 5, 2012.

(51) Int. Cl. G06F 19/00

(52) U.S. Cl. CPC G06F 19/3487
USPC 705/2

(57) ABSTRACT

A computer-implemented dietary analysis tool. More particularly, aspects of the present invention relate to computer implemented methods and systems configured to analyze a user's dietary intake based on information received from a user regarding her diet and exercise within a first time frame, such as for example, a twenty-four hour period.

This application claims the benefit of U.S. Provisional Application No. 61/620,573, filed Apr. 5, 2012, the entire disclosure of which is hereby incorporated by reference.

### FIELD OF THE INVENTION

This disclosure relates generally to a computer-implemented dietary analysis tool for athletes. More particularly, aspects of the disclosure relate to computer implemented methods and systems configured to analyze an athlete's dietary intake based on information received from the athlete regarding their diet and exercise within a first time frame, such as for example, a twenty-four hour period.

### BACKGROUND

As technology relating to clothing and other equipment relating to athletics continues to evolve and assist the athlete to reach certain goals that he or she may not otherwise have sought to accomplish, the energy that the athlete consumes and expends is still an important factor which when regulated can help an athlete succeed in his particular sport or event.

It is advantageous to have a quick method to assess dietary intake, as many individuals will not take the time to accurately complete food record forms. Assessing an individual's dietary intake is further complicated when the individual is an athlete. Sports dieticians working with athletes usually do not have much time to spend with athletes one-on-one, because the majority of the athlete's time is spent training or competing.

One recognized method of analyzing an individual's diet is referred to as the twenty-four hour dietary recall method. This method asks an individual to recall exactly what he or she consumed over a twenty-four hour period. The foods identified by the individual are matched against food information databases provided by the United States Department of Agriculture (“USDA”). However, such food information databases do not include sport-specific comestibles such as protein bars, energy beans, shakes and gels. Further, the traditional twenty-four hour dietary recall method does not question the individual regarding his exercise during the twenty-four hour period, nor does it specifically ask the individual to identify the foods and beverages consumed before, during, or after the exercise event. Thus, a need exists for a sports-specific dietary analysis method directed towards evaluating an athlete's diet in relation to exercise.

### BRIEF DESCRIPTION OF THE DRAWINGS

FIG. 1 illustrates an illustrative network architecture and dietary tool server that may be utilized in accordance with an aspect of the disclosure.

FIG. 2 is a flowchart of an example computer-implemented method of providing a dietary tool in accordance with one embodiment.

FIG. 3 shows a screen shot from a device application depicting a report generated in one aspect of the dietary analysis tool.

FIG. 4 is a flowchart depicting one aspect of the present disclosure, wherein the user inputs information to respond to a series of questions directed to foods and beverages consumed along with portion sizes.

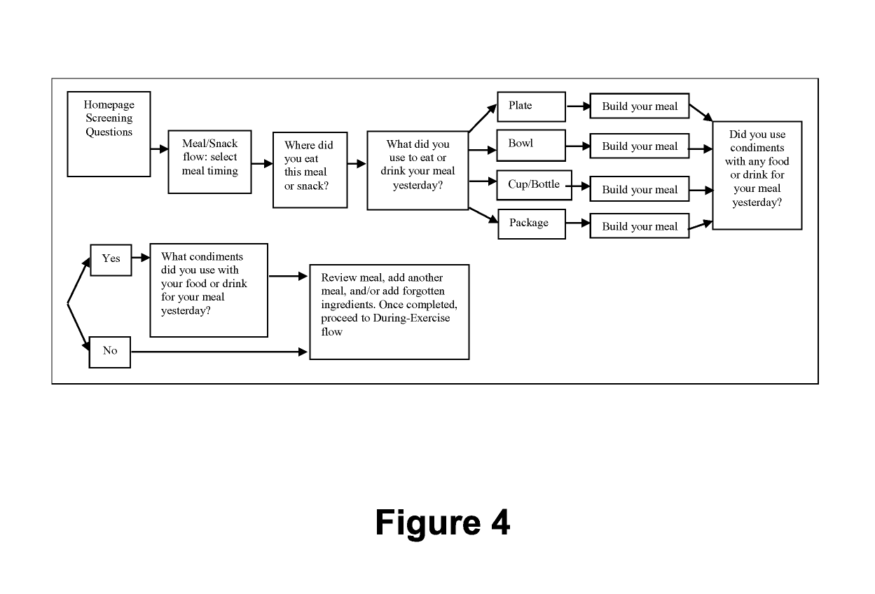

FIG. 5 is a flowchart depicting one aspect of the present disclosure, wherein the user inputs information to respond to a series of questions directed to exercise and foods and beverages consumed before, during and after exercise.

FIG. 6 shows a screen shot from a device application depicting food options for the user to choose in one aspect of the dietary analysis tool.

FIG. 7 shows another screen shot from a device application generated in one aspect of the dietary analysis tool.

### DETAILED DESCRIPTION

Aspects of the disclosure relate to a dietary analysis tool for individuals such as athletes. More specifically, aspects relate to systems and computer-implemented methods configured to provide a dietary analysis tool. In certain aspects, a dietary analysis tool may be configured to receive electronic information from an athlete, such as information relating to the foods and beverages consumed by the athlete and/or exercise performed by the athlete within a time period, such as for example, a twenty-four hour period. Certain embodiments relate to computer-implemented methods and systems configured to assess the dietary intake of an athlete. In one embodiment, the disclosure provides a dietary analysis method specifically for athletes including a sports comestible database. Various computer-implemented methods may generate a report breaking down the macronutrients, minerals, and vitamins consumed by the athlete, along with providing the athlete with the suggested amounts of these nutrients. For instance, the tool may break down the macronutrients including, without limitation, carbohydrate, fiber, sugar, protein, and fat consumed by the athlete. The tool may also break down the micronutirents consumed by the athlete including, without limitation, sodium, potassium, calcium, iron, magnesium, thiamin, riboflavin, niacin, pantothenic acid, and vitamin B6. In further embodiments, the tool may provide the athlete and/or another individual (such as a sports dietician) with an electronically-generated report including an analysis of total daily nutrient intake and an estimation of energy expenditure. In one aspect, the report may include an analysis of dietary intake consumed in a time frame (such as for example, four hours prior to exercise, during exercise, and in the hour after). In another aspect of the disclosure, the report may also include the amount of calories burned during the twenty-four hour period.

In the following description of the various embodiments, reference is made to the accompanying drawings, which form a part hereof, and in which is shown by way of illustration, various embodiments of the disclosure that may be practiced. It is to be understood that other embodiments may be utilized and structural and functional modifications may be made without departing from the scope of the present disclosure.

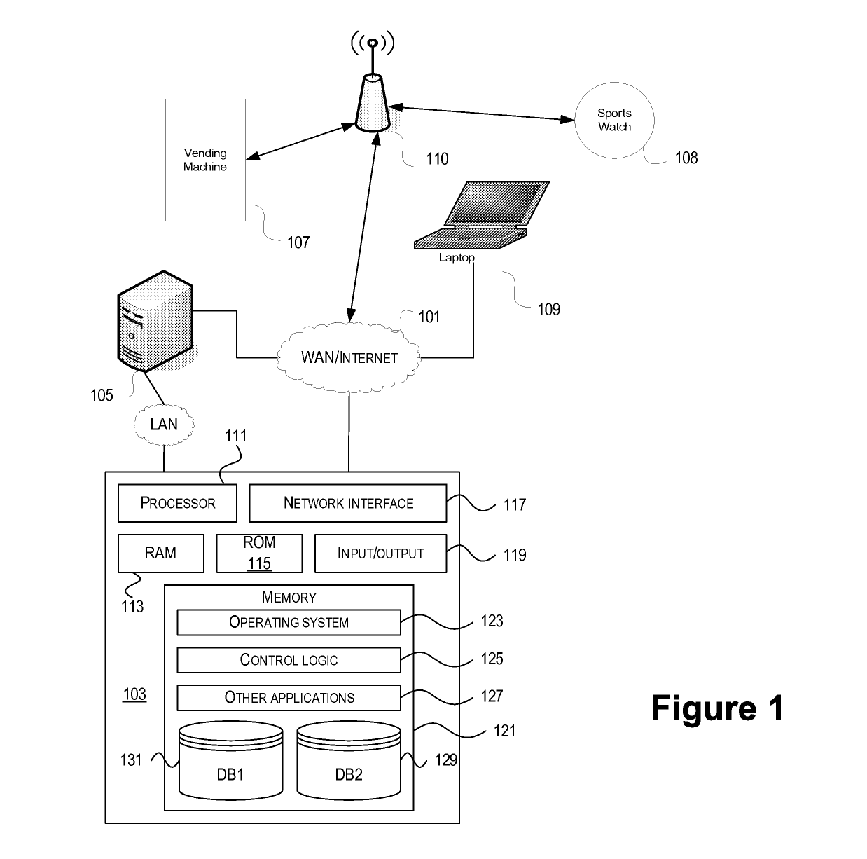

FIG. 1 illustrates one example of a network architecture and dietary information processing device that may be used to implement one or more illustrative aspects of the disclosure. Various network nodes 103, 105, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (such as sports watch 108 and/or other devices not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which may reside across all physical networks.

The components may include dietary tool server 103, dietary information server 105, vending machine 107, sports watch 108, and/or user computer 109. In one embodiment, dietary tool server 103 may provide overall access, control and administration of one or more collections of data (e.g., databases) and control software for performing one or more illustrative aspects of the disclosure as described herein. In one embodiment, dietary tool server 103 may be connected to dietary information server 105 through which users interact with and obtain data as requested. Alternatively, dietary tool server 103 may act as a dietary information server itself and be directly connected to the Internet. Dietary tool server 103 may be connected to dietary information server 105 through the network 101 (e.g., the Internet), via direct or indirect connection, or via some other network. Users may interact with the dietary tool server 103 using remote computer 109, e.g., using a web browser to connect to the dietary tool server 103 via one or more externally exposed web sites hosted by dietary information server 105. In addition, users may interact with dietary tool server 103 via a sports watch 108 or a vending machine 107 that may be found in a gym or other location. Such devices may be used in concert with dietary tool server 103 to access data stored therein, or may be used for other purposes. For example, from device 109 a user may access dietary information server 105 using an Internet browser, as is known in the art, or by executing a computer-executable instructions on a non-transitory computer-readable medium that communicates with dietary information server 105 and/or dietary tool server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and dietary processing devices used may vary, and are secondary to the functionality that they provide, as further described herein. For example, services provided by dietary information server 105 and dietary tool server 103 may be combined on a single server.

One or more of components 103, 105, 107, 108 and 109 may be any type of known computer, server, or data processing device. Looking to the example dietary tool server 103, it may include a processor 111 controlling overall operation of the dietary tool server 103. Dietary tool server 103 may further include RAM 113, ROM 115, memory 121 and/or any one or more non-transitory computer-readable mediums. As one example, memory 121 may further store operating system software 123 for controlling overall operation of the dietary tool server 103, control logic 125 for instructing dietary tool server 103 to perform aspects of the disclosure as described herein, and other application software 127 providing secondary support, and/or other functionality which may or may not be used in conjunction with aspects of the present disclosure. The control logic may also be referred to herein as the dietary tool server software 125. Functionality of the dietary tool server software may refer to operations or decisions made automatically based on rules coded into the control logic, made manually by a user providing input into the system, and/or a combination of automatic processing based on user input (e.g., queries, data updates, etc.). Those skilled in the art will realize that components 105, 107, 108 and 109 may also include similar hardware components (e.g., processor, RAM/ROM, memory, etc.) as discussed above with respect to dietary tool server 103.

Dietary tool sever 103 may further include network interface 117 and/or input/output interfaces 119 (e.g., keyboard, mouse, display, printer, etc.). I/O 119 may include a variety of interface units and drives for reading, writing, displaying, and/or printing data or files. Memory 121 may also store data used in performance of one or more aspects of the disclosure, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects of the disclosure may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

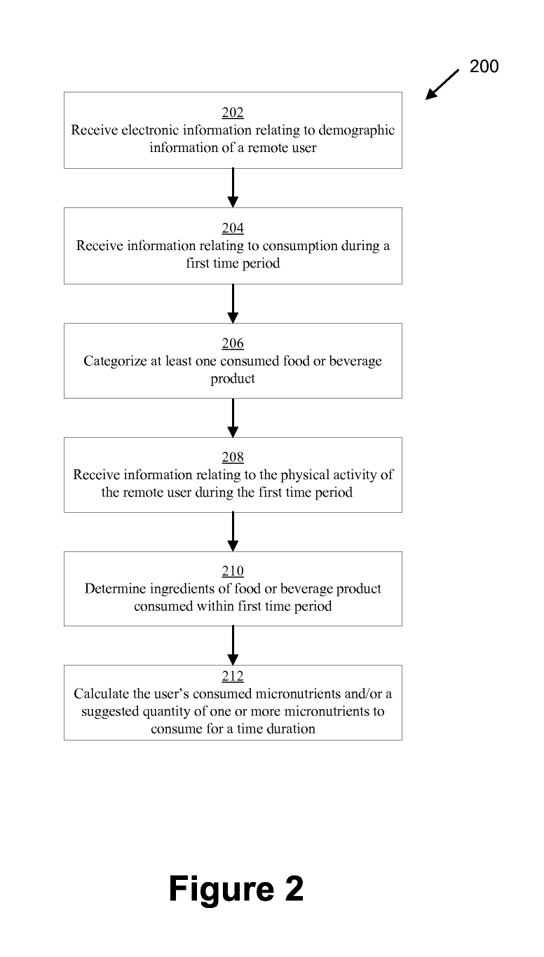

FIG. 2 shows a flowchart 200 of an example method that may be implemented in accordance with one embodiment of the disclosure. In one embodiment, a computer-implemented method may receive electronic information relating to a user (see, e.g., step 202). In one embodiment, the electronic information may be received through WAN 101 at dietary tool server 103, and/or dietary information server 105. At least a portion of the electronic information may have been received from a user input, such as from the athlete providing an input with an input/output device, such as described in relation to input/output 119. Such electronic information may include, without limitation, gender, age, height, weight and the type of athlete. The “type of athlete” may include, without limitation, competitive, recreational, fitness, beginner, elite/professional, and combinations thereof. In aspects of the disclosure, the electronic information may comprise information identifying dietary supplements consumed during a first time period, such as during a twenty-four hour period (not including sports performance supplements). In addition, the information (which may be received at step 202) may include information (such as in the form of responses to questions) relating to her food and beverage consumption throughout the time period (e.g. the twenty-four hour period).

In particular, at least a portion of the received electronic information may be responsive to inquiries provided, such as electronically transmitted to a user device (e.g., device 109). In one embodiment, information may be transmitted through WAN 101 and/or through wireless link 110 to device 108 that when displayed is configured to prompt the user to answer a series of questions about her dietary intake. For example, the athlete may be prompted to enter all meals and snacks consumed for the day. In addition, electronic information may be received that comprises data relating to a time the user began her meal and provides a rough estimate of how long it took her to consume the meal. Received information may include a location (e.g. home kitchen, cafeteria, locker room, etc.) of where she consumed her meal. As one of ordinary skill in the art at the time of the disclosure would recognize, the term “meal” shall mean a food, beverage, or combination of foods and/or beverages consumed by an individual.

In one aspect, a dietary analysis tool specifically for athletes may comprise a sports comestible specific database for use with the method. In particular, the method is computer-implemented and may be executed via a device application, such as on device 108 (e.g., a mobile device), and/or or a web browser. The tool may be configured to provide an individual (including, for example, the athlete and/or his sports dietician) with a report including an analysis of total daily nutrient intake and an estimation of energy expenditure.

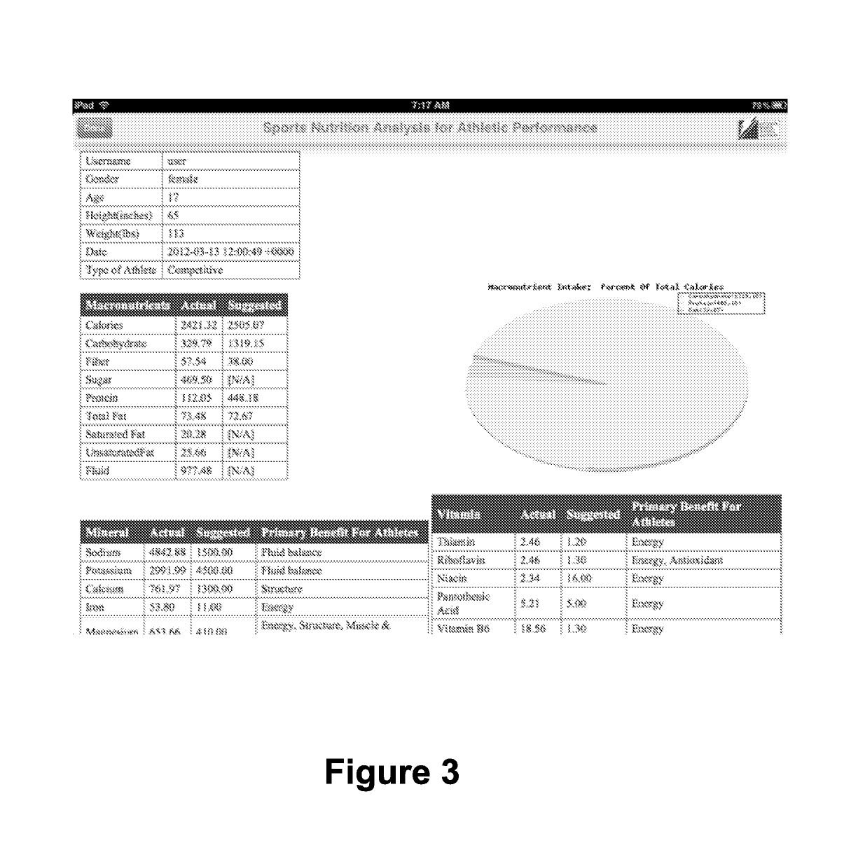

In one aspect of the present disclosure, as shown in the upper left portion of FIG. 3, a computer-implemented method, may include receiving the athlete's age, weight, height, and type of athlete. Either as part of step 202 and/or another process, electronic information regarding the time of consumption, duration of consumption, and/or where the food or beverage was consumed may be received (see, e.g., step 204). Further, FIG. 3 depicts a report generated by an exemplary embodiment of the present disclosure. In particular, FIG. 3 shows specific micronutrients and micronurtrients actually consumed by the athlete and the amounts of these nutrients suggested for the athlete.

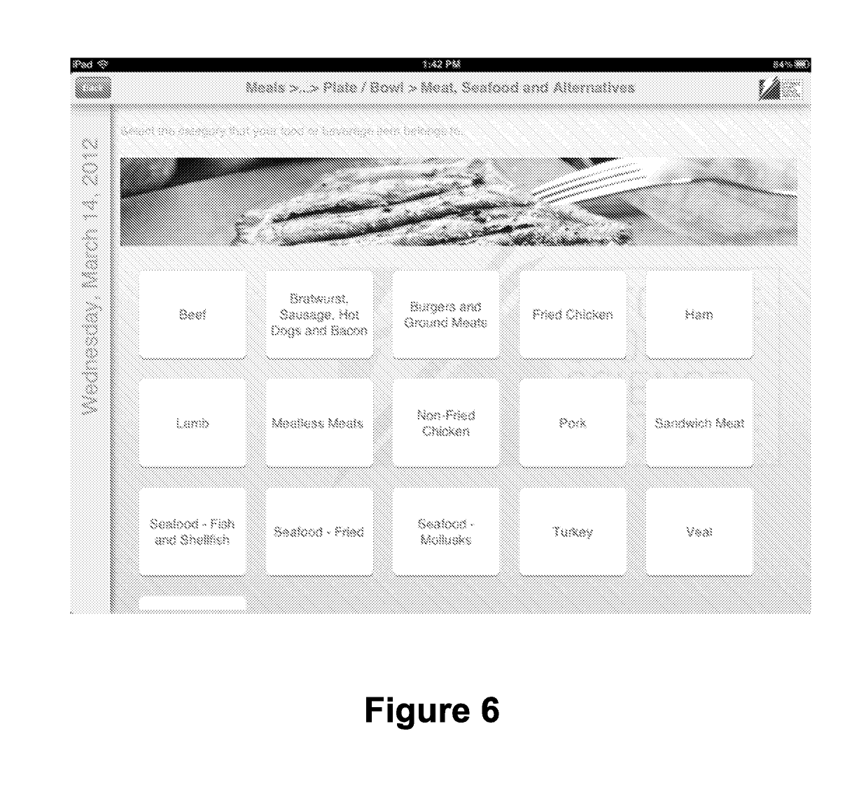

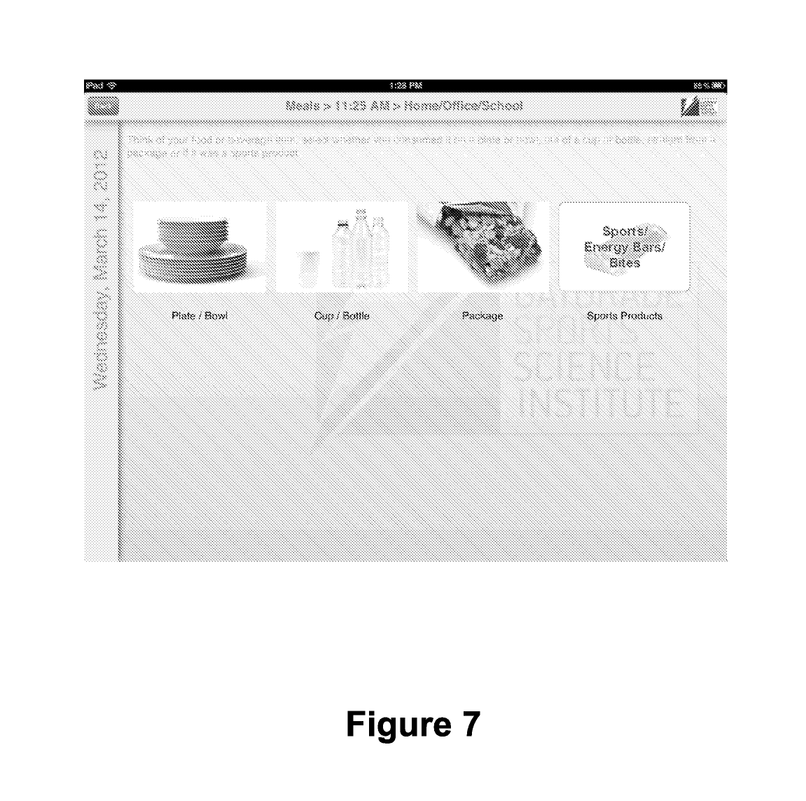

In certain implementations, more meal-specific information may be received from the athlete. For example, step 206 may be implemented to receive electronic information such as, but not limited to: whether the food or beverage item was consumed on a plate or bowl, out of a cup or bottle, straight from the package, and/or whether it was a sports product, and further shown in FIG. 7. A sports product as used herein shall mean a product primarily consumed by athletes in preparation for, during, or following an athletic activity. In step 206 the dietary tool server may receive electronic information, such as by reception of a user input from the athlete, identifying a category that the food or beverage item belongs to (which can include, without limitation: bread, cereal and granola, condiments, eggs; fruit; liquid dairy; meat, seafood and alternatives; nuts, nut butters, seeds and beans; solid dairy; soup; starches; sweets and desserts; vegetables and restaurant.) Based on the information received, the dietary tool server may determine various subcategories that the food or beverage item belongs to. For instance, as shown in FIG. 6, if the athlete selects “meat, seafood and alternatives,” he is further prompted to select among the following categories (options not all inclusive): beef; bratwurst, sausage, hot dogs and bacon; burgers and ground meats; friend chicken; ham; lamb; meatless meats; non-fried chicken; pork; sandwich meat; seafood—fish and shellfish; seafood—fried; seafood-mollusks; turkey; and veal. The serving size of the food or beverage item may also be received. The user may be prompted to continue answering the food and beverage specific inquiries until he has specifically identified all of the foods and beverages consumed within a specific twenty-four hour period.

In certain implementations, a user input may identify information that is not listed as a selection. For example, if the user consumed a food or beverage that is not listed as a category or subcategory, the user can enter as much nutrition information as is available for the comestible, which may be received at server 103 and/or 105.

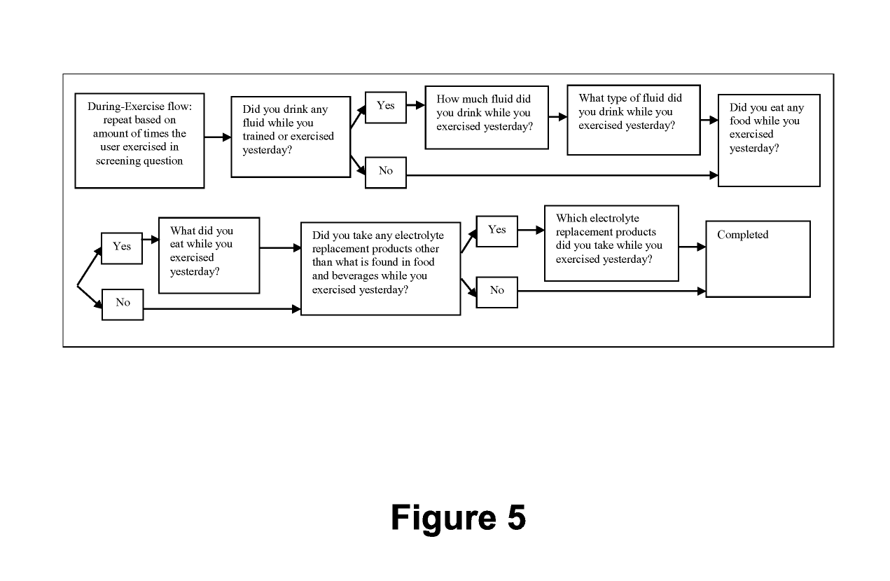

In step 208 the dietary tool server may receive electronic information relating to physical activity performed by a user. As one example, FIG. 5, shows one exemplary flowchart that may be wholly or partially implemented to receive information specifically related to the exercise performed by the athlete, including, without limitation, amount of times the athlete trained or exercised during the twenty-four hour period, duration of the training session (for each training session), the type of exercise (including running, cycling, swimming, weight training, dancing, elliptical, team sports, individual sport practice, flexibility exercise programs or personal training, and other), and/or combinations thereof. Electronic information may also include whether he participated in any recreational or “pick-up sports” during the twenty-four hour period. The computer-implemented method may prompt the user to input exercise specific information by answering a series of questions relating to exercise. In yet other embodiments, it may be electronically received from a computing device, such as an electronic device worn by the user that is configured to collect physical activity data, and/or a device in communication with exercise equipment. It may be automatically received upon the athlete using the device, on demand, and/or during regular intervals. In one embodiment, the athlete identifies if a fluid was drunk during training or exercise and if so, how much fluid was drunk and/or the type of fluid drunk. In addition, received information may include any foods consumed during exercise and what type of food was consumed. Further, the electronic information may identify whether any electrolyte replacement products were consumed during exercise and if so what specific products.

Certain embodiments may compare the food and beverages consumed by the athlete to a collection of electronically stored products. In one embodiment, at least a portion of the collection may be stored on one or more computer-readable mediums located on dietary information server 105. In accordance with one implementation, step 210 may utilize information from one or more of steps 202-208 to compare received electronic data with a database. As one example, a database or collection of electronically stored products may comprise the products in the USDA databases, restaurant databases, and/or a sports-specific database. One or more entries may be copied and/or transferred to dietary information server 105 and/or any other tangible non-transitory computer-readable medium(s). In one embodiment, electronic information received from steps 204-206 may be used to calculate ingredients in one or more food or beverage products. For example, in one embodiment, by comparing the food and beverage selections to these databases, certain embodiments may break down the macro and micronutrients contained in the food and beverage items. In step 212 the method, at the dietary tool server, may calculate the user's consumed micronutrients and/or a suggested quantity of one or more micronutrients to consume for a specific duration (such as the twenty-four hour period). In one embodiment, step 212 may be implemented to generate an output based which compares the athlete's actual intake to the suggested amounts for the macro and micro nutrients. In an alternative aspect of the disclosure, “the primary benefit for athletes” is listed for each of the micronutrients identified. One example of a report generated by the instant method is shown in FIG. 3. The report may also include actual dietary intake by the athlete before, during, and after each training session or competition. The report may also include the number of calories burned/energy expended by the athlete in the twenty-four hour period.

In an alternative aspect of the present disclosure, the suggested values for sport nutrition intake are included in the report. These suggested values may be included in addition to or in lieu of the actual values for sport nutrition intake. In one aspect of the present disclosure, the athlete is provided with a sports nutrition report identifying the macronutrients, minerals, and vitamins consumed during the twenty-four hour period, comparisons of the actual amounts consumed by the athlete to suggested amounts, and total energy expenditure during the twenty-four hour period.

In an alternative aspect, the report generated for the athlete may include supplemental information for the athlete such as the primary benefit of a specific nutrient and/or an explanation of how the nutrient contributes to the athlete's diet and his performance. In yet another aspect of the present disclosure, the report also includes an analysis of nutrients consumed in the four hours prior to exercise, during exercise, and in the hour after.

The reports as described herein may also be electronically transmitted to a health professional, such as a sports dietician for further analyzing or recommending a nutrition plan to enhance the athlete's athletic performance. In certain embodiments, minimal user inputs are required to provide comprehensive dietary information. In one embodiment, a user may only need to spend about 15-20 minutes to provide the necessary information. Yet in other embodiment, drastically less time may be required.

In one aspect of the disclosure, the user may be a dietician or other qualified professional interviewing an athlete using this tool to assess the athlete's dietary intake and exercise within a 24-hour period. In an alternative aspect of the disclosure, the athlete may be the user.

The accuracy and reliability of the dietary analysis tool described herein was assessed by measuring its agreement with a recognized reference method (twenty-four hour dietary recall interview using the USDA's Multiple Pass Method) (“USDA Method”). Fifty-six athletes across two testing sites completed testing with the present dietary analysis tool and the USDA Method in random order. The reliability of the instant dietary analysis tool compared to the USDA Method was assessed with a subset of subjects (30 total) by repeating the methods 1-2 weeks after their first visits. Paired comparison with 95% confidence intervals were used to determine statistical agreement between the dietary analysis tool and the USDA Method. Overall, the instant dietary analysis tool was found to have acceptable accuracy and reliability for estimating twenty-four hour energy/calories, carbohydrate, sodium, iron and calcium intake when compared to the traditional USDA Method.

While the invention has been particularly shown and described with reference to various aspects, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

We claim:

1. A computer-implemented method of evaluating the diet of a user comprising:
receiving at a dietary tool server, electronic information from a user relating to consumption of food and beverage items, type of exercise, and duration of exercise in a twenty-four hour period;
comparing at the dietary tool server the food and beverage item information received from the user to a collection of food and beverage items comprising a database listing products, a database of restaurant-specific nutrition information, and a sports nutrition database containing sports nutrition products;
calculating at the dietary tool server at least a total nutrient intake during the twenty-four hour period; and
generating a report based on the information received from the user comprising the calculated total nutrient intake.

2. The computer-implemented method of claim 1, wherein the report includes an analysis of the total daily nutrient intake and an estimation of energy expenditure that are calculated at least in part based upon the information received from the user.

3. The computer-implemented method of claim 2, wherein the analysis of total daily nutrient intake includes a breakdown of the macronutrients, minerals, and vitamins consumed by the user to suggested amounts based on the type and duration of the exercise in the twenty-four hour period.

4. The computer-implemented method of claim 2, wherein the report further includes an analysis of nutrients consumed by the athlete in the four hours prior to a first exercise, during the first exercise, and within an hour after the first exercise.

5. The computer-implemented method of claim 1 further comprising:
transmitting the report to a remote user through a network.

6. The computer-implemented method of claim 1 wherein the electronic information is received at a mobile device and the method further comprising:
outputting the electronic report on a display device of the mobile device.

7. The computer-implemented method of claim 1 wherein the report is electronically transmitted to a health professional for further analysis.

8. The computer-implemented method of claim 2, wherein the report further includes a graph depicting the amount of carbohydrates, protein and fat compared to the total calories consumed by the user.

9. The computer-implemented method of claim 1, wherein the report further includes an explanation of the primary benefit of the nutrients

10. A computer-implemented method of evaluating the diet of a user comprising:
receiving at a dietary tool server, electronic information from a user relating to consumption of food and beverage items, type of exercise, and duration of exercise in a twenty-four hour period;
comparing at the dietary tool server the food and beverage item information received from the user to a collection of food and beverage items comprising a database listing products, a database of restaurant-specific nutrition information, and a sports nutrition database containing sports nutrition products;
calculating at the dietary tool server at least a total nutrient intake during the twenty-four hour period and a suggested nutrient intake based on the electronic information received from the user;
comparing at the dietary tool server the total nutrient intake during the twenty-four hour period to a suggested nutrient intake during the twenty-four hour period; and
generating a report based on the information received from the user comprising the calculated total nutrient intake and the suggested nutrient intake.

11. The computer-implemented method of claim 10, wherein the report includes an analysis of the total daily nutrient intake and an estimation of energy expenditure that are calculated at least in part based upon the information received from the user.

12. The computer-implemented method of claim 11, wherein the analysis of total daily nutrient intake includes a breakdown of the macronutrients, minerals, and vitamins consumed by the user to suggested amounts based on the type and duration of the exercise in the twenty-four hour period.

13. The computer-implemented method of claim 11, wherein the report further includes an analysis of nutrients consumed by the athlete in the four hours prior to a first exercise, during the first exercise, and within an hour after the first exercise.

14. The computer-implemented method of claim 10 further comprising:
transmitting the report to a remote user through a network.

15. The computer-implemented method of claim 10 wherein the electronic information is received at a mobile device and the method further comprising:
outputting the electronic report on a display device of the mobile device.

16. The computer-implemented method of claim 11, wherein the report further includes a graph depicting the amount of carbohydrates, protein and fat compared to the total calories consumed by the user.

17. The computer-implemented method of claim 10, wherein the report is electronically transmitted to a health professional for further analysis.

18. The computer-implemented method of claim 10, wherein the report further includes an explanation of the primary benefit of the nutrients.

19. A computer-implemented method of evaluating the diet of a user comprising:
receiving at a dietary tool server, electronic information from a user relating to consumption of food and beverage items, type of exercise, and duration of exercise in a twenty-four hour period;
determining a suggested nutrient intake for the user based on a twenty-hour period;
comparing at the dietary tool server the food and beverage item information received from the user to a collection of food and beverage items comprising a database listing products, a database of restaurant-specific nutrition information, and a sports nutrition database containing sports nutrition products;
calculating at the dietary tool server at least a total nutrient intake during the twenty-four hour period;
comparing at the dietary tool server the total nutrient intake during the twenty-four hour period to the suggested nutrient intake for the twenty-four hour period; and
generating a report based on the information received from the user comprising the calculated total nutrient intake and the suggested nutrient intake.

20. The computer-implemented method of claim 19, wherein the report includes an analysis of the total daily nutrient intake and an estimation of energy expenditure that are calculated at least in part based upon the information received from the user.
